(19) United States
(12) Patent Application Publication
(10) Pub. No.: US 2020/0390132 A1
(43) Pub. Date: Dec. 17, 2020

(54) METHOD OF PREPARING FROZEN POULTRY MEAT PORTIONS

(71) Applicant: Harrison Poultry, Inc., Bethlehem, GA (US)

(72) Inventors: David BLETH, Bethlehem, GA (US); Jens EYSTEINSSON, Monroe, GA (US)

(73) Assignee: Harrison Poultry, Inc., Bethlehem, GA (US)

(21) Appl. No.: 16/442,803

(22) Filed: Jun. 17, 2019

(51) Int. Cl. A23L 13/50; A22C 21/00; A22C 7/00; A23B 4/10

(52) U.S. Cl. CPC A23L 13/52; A22C 21/00; A22C 7/0023; A23V 2300/20; A23B 4/10; A23V 2002/00; A23L 13/57

(57) ABSTRACT

A method of preparing frozen breaded poultry meat in which the poultry meat is compressed into a solid form, frozen, formed into portions, batter-breaded while frozen, and par-fried. The par-fried breaded poultry meat portions may then be cooked for consuming. The method enables the control of portion size independent of the shape, and provides a frozen breaded poultry meat portion that when cooked, has the appearance and the texture of whole muscle meat, independent of trimmings content.

### BACKGROUND

In the prepared meat industry, in particular the frozen breaded fish and frozen breaded poultry industry, the producer seeks to minimize waste, and consumers prefer that the meat resemble the original whole muscle meat.

In the frozen breaded fish industry, for example, freshly caught fish is filleted, assembled into blocks, and frozen while on the fishing vessel. After the frozen blocks arrive on shore, they are cut into shims. Various shapes are pressed from the frozen shims. The pieces, whether from fillet form or trim pieces, are pressed into a forming mold and adhere together to form a frozen block. The resulting shapes, or portions, cut and pressed or stamped from the shims have uniform portion sizes and weight. The portions are surface tempered and subsequently batter-breaded. The batter-breaded fish is subsequently par-fried.

In the frozen breaded poultry industry, the meat used may be whole muscle meat, chopped or ground muscle meat, and, in an effort to reduce waste, producers may include various scraps of muscle meat, herein after referred to as “trimmings.” The conventional methods for preparing frozen breaded poultry meat portions, such as strips or patties, involve forming fresh meat into a desired shape and portion size (by weight), batter-breading, par-frying, individually quick freezing portions (IQF), packaging as IQF portions and storing. However, the conventional preparation methods have several drawbacks.

The conventional methods for preparing frozen breaded portions generally use one of two techniques for forming the desired shape and portion. One technique involves waterjet cutting or knife cutting from a section of whole muscle meat, but this technique generates a secondary product and does not provide a uniform portion size (by weight). This aforementioned secondary product includes excess muscle meat removed during the cutting process as well as trimmings. The excess whole muscle meat can be cut into smaller portions known as nuggets, but this still generates trimmings. The other forming technique involves forming fresh, emulsified, ground, chopped, marinated fresh or whole muscle poultry meat, with shape-forming equipment to shape the product into desired portions (FORMAX® or Versaform-type equipment). There is typically less waste associated with this technique because the meat is ground or chop together and may include the trimmings. The shape of the portions are controlled, but there can be a variation in portion size by weight due to a range of solid meat concentration, for example fat in the emulsion weighs less than whole muscle trimmings in the emulsion, and this detracts from portion control. The resulting appearance and texture of these fresh formed poultry meat portions are noticeably different from whole muscle poultry meat.

Similar to the frozen breaded fish industry, the par-fry step for preparing frozen breaded poultry meat portions is prone to create waste and alter the appearance. The poultry meat portions are subjected to batter-breading, and the batter-breaded portions are par-fried. During par-frying, the batter-breading can separate from the meat. In general, this is due to the fresh state of the meat, which is wet, when the poultry meat portions are subjected to batter-breading. The batter-breading does not stay well adhered to the wet meat surface during par-frying. In an attempt to overcome this problem, an additional pre-dusting stage has been added during which a pre-dusting batter is applied to the poultry meat portions before the batter-breading is applied. The pre-dusting batter adheres to the wet meat surface and improves the adherence of the batter-breading during par-frying. However, pre-dusting does not completely eliminate the wet surface, and the batter-breading may nevertheless fall off during par-frying.

### SUMMARY

Accordingly, an object of the invention is to provide a method of preparing frozen breaded poultry meat portions, such as frozen breaded chicken portions, that enables the control of portion size independent of the shape, improves the breading adhesion to the meat surface during par-frying without the need for an additional pre-dusting stage in at least one exemplary embodiment, and provides a frozen breaded poultry meat portion that when cooked, has the appearance and the texture of whole muscle meat, independent of trimmings content.

The method includes compressing whole muscle frozen poultry meat and/or trimmings to form a compressed solid, thereby providing a consistent meat density. Optionally, the poultry meat is marinated prior to compressing. In at least one exemplary embodiment, the compressed solid is a block form. After the compressed solid is frozen, it is optionally cut into smaller sections, and the smaller sections are optionally subjected to pressing to obtain a desired shape. Alternatively, the frozen compressed solid is of a desired shape without pressing. Because of the consistent meat density achieved by the compression step, a consistent portion size (by weight) may be obtained, regardless of the portion shape. The frozen poultry meat portions are surface tempered, batter-breaded, and subsequently par-fried without breading loss. The par-fried poultry meat portions, which maintain a core frozen temperature, are blast frozen, packaged, and stored under freezing conditions. The resulting baked or fried breaded poultry meat portions have the appearance and texture of whole muscle poultry meat, independent of whether the meat is from whole muscle meat or trimmings.

In at least one exemplary embodiment, the poultry meat used in the frozen breaded poultry meat portions is substantially or entirely trimmings. The trimmings are obtained fresh from a poultry meat processing line. While the meat is substantially or entirely trimmings, the resulting baked or fried poultry meat portions have the appearance and texture of whole muscle poultry meat.

### BRIEF DESCRIPTION OF THE FIGURES

Advantages of embodiments of the invention will be apparent from the following detailed description of the exemplary embodiments. The following detailed description should be considered in conjunction with the accompanying figures in which:

FIG. 1 illustrates an exemplary process by which the frozen breaded poultry meat portions may be prepared.

FIGS. 2a to 2c show cooked breaded chicken portions. FIG. 2a is a trimmings-based chicken portion according to the invention. FIG. 2b shows a cooked breaded whole muscle meat-based chicken portion. FIG. 2c shows a conventional cooked breaded shape-formed chicken portion.

### DETAILED DESCRIPTION

Aspects of the invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

The invention provides a method of preparing frozen breaded poultry meat portions. The poultry meat source is not limited in terms of the type of bird or the type of meat from the bird. The poultry meat may be from whole muscle meat and/or trimmings. The whole muscle meat may be chopped, ground, or in other forms that do not resemble the original whole muscle meat. The trimmings advantageously are freshly separated from a poultry meat processing line. In this respect, the invention has the advantage of utilizing poultry meat that would otherwise be sold at reduced trimmings price or discarded as waste.

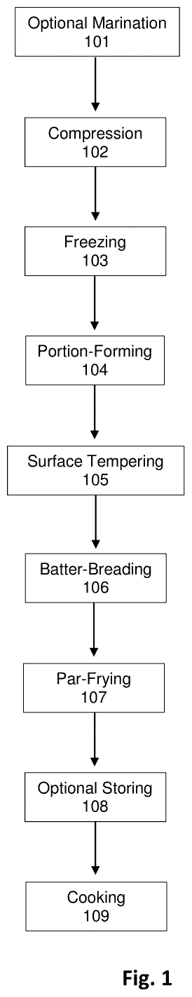

According to the exemplary embodiment illustrated in FIG. 1, the method may involve the steps of optional marination 101, compression 102, freezing 103, portion-forming 104, surface tempering, 105 batter-breading 106, par-frying 107, optional storing 108, and cooking 109 the poultry meat portion.

The compression step 102 provides an advantage of the invention. The compression results in generally consistent density so that the resulting portion size (by weight) is generally consistent. Thus, the compression step may be used, in combination with the subsequent portion-forming step 104, to provide different shaped portions, all with the same weight, or portion size. Compression may be carried out using hydraulic press or equivalent, wherein the poultry meat is subjected to pressure in the range of 900 to 1,500 lbs/ft.² to form frozen blocks. The compression step 102 is not limited to compressing the poultry meat into any specific shape, and the compressed poultry meat may comprise one or more portions of meat. Also, the poultry meat may be subjected to the optional marination step 101 prior to the compression step 102. In at least one embodiment, the poultry meat is compressed into a block form, which may be divided and subsequently shaped into portions, each having the desired shape and portion size. Alternatively, in at least one embodiment, the poultry meat is compressed into multiple block form compartments in which the compression step 101 includes the simultaneously formation of two or more block forms, which may be shaped into portions of the desired shape and portion size.

The compressed poultry meat is subjected to a freezing step 103 at a temperature in the range of −40° F. to 25° F., such as −25° F. to 25° F. or −10° F. to 20° F. to provide a frozen compressed poultry meat with the same temperature range. Freezing may be carried by any desired means capable of lowering the compressed poultry meat temperature to the above-mentioned ranges such as freezing product in blast freezer or the equivalent thereof.

In at least one exemplary embodiment, the steps of compression 102 and freezing 103 are carried out simultaneously following the above-described conditions for pressure and temperature.

The desired portion shape(s) and portion size(s) are obtained from the frozen compressed poultry meat during the portion-forming step 104. A desired shape may be a patty, suitable for a sandwich, or a strip, or a nugget for example. In some exemplary embodiments, the portion-forming step 104 comprises tempering the frozen compressed poultry meat to facilitate cutting, cutting the frozen compressed poultry meat, for example using block cutter (i.e. band saw), to obtain the portions of a desired shape and portion size. In other exemplary embodiments, portion-forming step 104 comprises tempering the frozen compressed poultry meat to facilitate pressing and subjecting frozen compressed poultry meat to pressing with 170,000 lbs. of force to 250,000 lbs. of force, for example using a portion forming press (such as those available from Elite Metal Tools), to form at least one desired shape of a specific portion size. In other exemplary embodiments, the frozen compressed poultry meat is too large to form a portion by cutting or too large for pressing, and the portion-forming step 104 comprises tempering the frozen compressed poultry meat to facilitate cutting, cutting the frozen compressed poultry meat and subsequently pressing the cut, frozen compressed poultry meat to obtain the desired shape and portion size. For example, the frozen compressed poultry meat may be in a block form, and step 104 comprises tempering to facilitate cutting, cutting the block, (for example, with a block cutter band saw) to divide the frozen compressed poultry meat into smaller frozen sections, or shims, and pressing the shims, (for example a portion forming press) to obtain the portions of the desired shape and portion size. In other exemplary embodiments, the frozen compressed poultry meat may be in multiple compartment block forms, and as such step 104 comprises separating the pre-divided, compartment blocks (with or without a device for cutting such as a block cutter band saw) into smaller frozen sections and optionally pressing the sections (for example a portion forming press) to obtain the portions of the desired shape and portion size.

However, in at least one exemplary embodiment, the poultry meat after compression step 102 and freezing step 103 has the desired shape and portion size without the need of either cutting or pressing, and, thus, the portion-forming step 104 is part of the compression step 102.

Once the desired frozen compressed poultry meat portion(s) are obtained, the portion(s) are subjected to the steps of surface tempering 105, batter-breading 106, and par-frying 107.

Another advantage of the present is realized by the surface tempering step 105. In at least one exemplary embodiment, the surface tempering step 105 involves immersing the frozen compressed poultry meat portions in a hot water bath for a sufficient time to create a warm and moist or wet outer surface, while maintaining a frozen core temperature. The temperature of the hot water bath may be from 130° F. to 211° F., such as from 130° F. to 160° F. or from 140° F. to 150° F., and the immersion time may be 0.5 second to 10 seconds, such as from 1 to 7 seconds or from 2 to 5 seconds. The surface tempering step 105, while warming the outer surface of the poultry meat portions, does not significantly heat the core of the poultry meat portions, which remain frozen, for example, at a temperature of −40° F. to 25° F., such as −25° F. to 27° F., or −10° F. to 22° F.

The surface tempered poultry meat portions are then subjected to the batter-breading step 106. The batter-breading step 106 may include two applications, either or both application may be carried out using a batter-breading machine or equivalent, or manually. First, a viscous batter is applied to the warmed and moist outer surface, followed by a thicker batter/breading. Optionally, the warmed and moist outer surface may be pre-dusted before the viscous batter is applied. During the batter-breading step 106, the tempered poultry meat portions remain frozen at a core temperature of −40° F. to 25° F., such as −25° F. to 27° F., or −10° F. to 22° F.

The advantage of the surface tempering step 105 is that the poultry meat portions have moist outer surfaces during the batter-breading step 106 to enable the initial adherence of the batter-breading and frozen cores to assure that the adherence of the batter-breading is maintained even during the par-frying step 107. Moreover, because of this assured adhesion the pre-dusting prior to batter-breading in step 106 is optional.

The inventors have discovered that the improved adhesion is a result of the outer surfaces of the poultry meat portions reaching a temperature closer to that of the frozen cores as the temperature of the poultry meat portions approach equilibrium prior to par-frying. The frozen or near frozen surfaces of the poultry meat portions strengthen the adhesion of the batter-breading, and, as a result, loss of the breading and/or poultry meat is generally avoided during the par-frying step 107.

The par-frying step 107 can be carried out, for example, in a conventional manner, with use of an oil fryer and with an oil temperature of 240° F. to 480° F., such as 270° F. to 440° F. or 300° F. to 400° F., for a time from 10 seconds to 120 seconds, such as 20 seconds to 90 seconds or 30 seconds to 60 seconds, so as to form a golden brown surface.

The par-fried breaded poultry meat portions may be optional stored as specified in step 108 or cooked in cooking step 109, for example baking or frying.

In at least one exemplary embodiment, the method includes the step of storing 108 the par-fried breaded poultry meat portions at a frozen temperature before cooking such as within the range of −40° F. to 25° F., including as −25° F. to 27° F., or −10° F. to 22° F.

In at least one exemplary embodiment, the optional storing step 108 comprises packaging the par-fried breaded poultry meat portions in a suitable material (for example in vacuum sealed packages, etc.).

The above-discussed advantage of the compression step 102 combined with the subsequent portion forming step 104 is recognized when it is desirable to package a variety portion shapes, all with the same portion size by weight.

For the cooking step 109, the par-fried breaded poultry meat portions may be baked or fried.

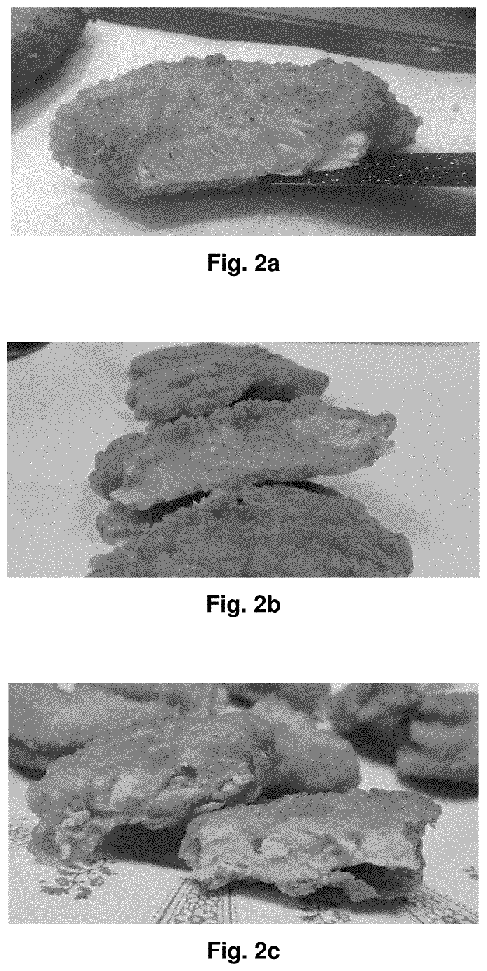

An advantage of the invention, which is evident after the cooking step 108, is that the appearance and texture resembles whole muscle poultry meat, even when the poultry meat used to form the poultry meat portions consists of trimmings or a sufficient amount of trimmings such that the appearance of the meat would not resemble whole muscle meat without utilizing the steps according to the invention. This advantage is readily apparent in FIGS. 2a to 2c, which compare fried breaded chicken portions of various preparation methods and comprised of varying meat contents. FIG. 2a is chicken portion made from 100% trimmings according to the invention. FIG. 2b shows a whole muscle meat-based chicken portion. FIG. 2c shows a conventional shape-formed chicken portion. The chicken portion according to the invention, which includes trimmings, is more similar in appearance to the 100% whole muscle portion than the conventional shape-formed portion.

Breaded chicken portions prepared according to the invention, in which the poultry meat consists of trimmings were evaluated in terms of texture, or bite, by group of potential customers of the product and end consumers.

The chicken trimmings were compressed into blocks at a pressure of 170,000 to 250,000 lbs. of force and frozen to a temperature of −40° F. to 25° F. The frozen blocks were cut into shims and subsequently pressed into portions with a pressure of 1,200 lbs. per ft² of a desired shape and portion size. The frozen portions were tempered at a temperature from 140° F. to 150 ° F. for 2 seconds, batter-breaded, and par-fried at 350° F. for 30 seconds.

The test panel of participants determined that the chicken portions had a bite that matched that of whole muscle quality.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments may be made by those skilled in the art without departing from the scope of the invention as defined by the following claims.

1. A method for preparing breaded poultry meat, comprising:
obtaining trimmings removed from whole muscle poultry meat as scraps;
forming compressed poultry meat from the trimmings, said forming consisting of compressing poultry meat comprising consisting of the trimmings from one or more poultry carcasses into a single compressed form;
freezing the compressed poultry meat;
forming frozen poultry meat portions from the frozen compressed poultry meat;
surface tempering the frozen poultry meat portions;
coating the frozen poultry meat portions with a batter-breading; and
par-frying the frozen batter-breaded poultry meat.

2. (canceled)

3. The method according to claim 1, further comprising freeze-storing the par-fried breaded poultry meat.

4. The method according to claim 1, further comprising cooking the par-fried breaded poultry meat.

5. The method according to claim 1, wherein forming frozen poultry meat portions comprises cutting the frozen compressed poultry meat.

6. The method according to claim 5, wherein forming frozen poultry meat portions comprises tempering the frozen compressed poultry meat to facilitate cutting, cutting the frozen compressed poultry meat into sections after tempering, and pressing the sections of frozen compressed meat into portions.

7. The method according to claim 6, wherein pressing the sections of frozen compressed meat into portions is carried out under a pressure of at 170,000 to 250,000 lbs of force.

8. The method according to claim 6, further comprising freeze-storing the par-fried breaded poultry meat.

9. The method according to claim 6, further comprising cooking the par-fried breaded poultry meat.

10. The method according to claim 1, further comprising freeze-storing the par-fried breaded poultry meat.

11. The method according to claim 1, further comprising cooking the par-fried breaded poultry meat.

12. and 13. (canceled)

14. The method according to claim 1, wherein the single compressed form is a block, and the poultry meat is compressed at a pressure of 900 lbs./sq. ft. to 1,500 lbs./sq. ft.

15. The method according to claim 1, wherein the compressed poultry form is frozen to a temperature of −40° F. to 25° F.

16.-19. (Canceled)

20. A batter-breaded poultry meat portion comprising a breaded outer layer covering compressed poultry meat comprised consisting of trimmings and/or whole muscle meat, wherein the poultry meat portion resembles a whole muscle portion.

21. (canceled)

22. The method according to claim 1, wherein compressing is performed a hydraulic press.

23. The method according to claim 15, wherein the temperature the compressed poultry form is frozen to a temperature of −10° F. to 25° F.
